(19) United States
(12) Patent Application Publication
(10) Pub. No.: US 2013/0286184 A1
(43) Pub. Date: Oct. 31, 2013

(54) APPARATUS FOR DETECTING AND MEASURING CYLINDRICAL SURFACES ON FIREPROOF CERAMIC COMPONENTS IN METALLURIGAL APPLICATIONS

(71) Applicant: Gunther Paul, Trieben (AT)

(72) Inventor: Gunther Paul, Trieben (AT)

(73) Assignee: REFRACTORY INTELLECTUAL PROPERTY GMBH & CO. KG, Wien (AT)

(21) Appl. No.: 13/979,059

(22) PCT Filed: Dec. 29, 2011
(86) PCT No.: PCT/EP11/74260

§ 371 Date: Jul. 10, 2013

(30) Foreign Application Priority Data
Feb. 19, 2011 (EP) 11001378.6

(51) Int. Cl. H04N 7/18

(52) U.S. Cl. CPC H04N 7/183
USPC 348/84

(57) ABSTRACT

The invention relates to an apparatus for detecting and measuring cylindrical surfaces on fireproof ceramic components in metallurgical applications.

The invention relates to a device for the detection and measuring of cylindrical surfaces of fireproof ceramic components in metallurgical applications.

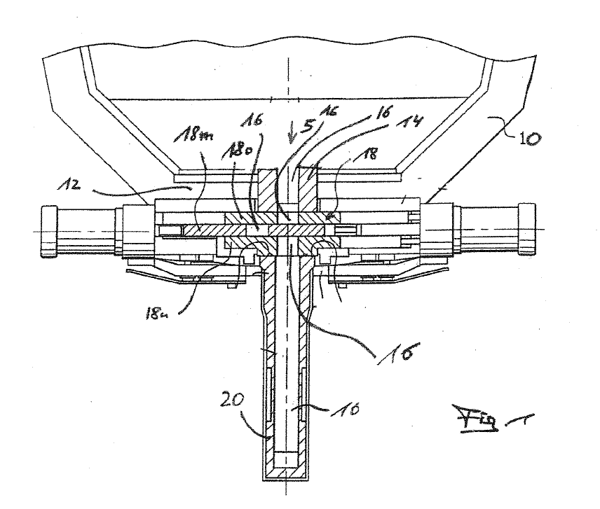

FIG. 1 shows a typical metallurgical application, without limiting it in the context of the invention. A metallurgical vessel 10 lined with a fireproof base 12 is visible, inside which a generally cylindrical fireproof ceramic outlet 14 is located, which features a central discharge opening 16, through which a metal melt flows from the metallurgical vessel 10 into successive aggregates.

In stream-direction of the melt (arrow S), the outlet 14 is followed by a sliding-gate (valve) 18 with an upper sliding-plate 18o, a central sliding-plate 18m and a lower sliding-plate 18u, to which a submerged entry nozzle 20 is connected. All of the aforementioned components feature discharge openings for the metal melt, corresponding to the discharge channel 16, hence why the corresponding segments in FIG. 1 are also labelled 16.

It follows from FIG. 1, that the central siding-pate 18m is movable, in order to be moved from a locking position (FIG. 1) into a position, where all the discharge openings 16 are aligned to allow the flowing through of the metal melt.

The aforementioned components (outlet 14, siding-plates 18o, 18m, 18u, submerged nozzle 20) feature cylindrical inner surfaces for the definition of the respective discharge openings 16. Herein the term “cylindrical” is not to be understood in an exact mathematical sense, but in technical terms.

It is known that the fireproof (refractory) components wear out through the metallurgical attack of the melt (erode) or contrary, that agglomerates are formed on the surfaces (so called clogging).

The wear as well as the clogging on the surfaces of the discharge channels 16 seriously interferes with the casting (pouring) process. It is therefore necessary to regularly be informed about the geometry of the discharge channels 16, in order to draw conclusions, for example the replacement of an already excessively worn component or the burning off/chipping off of agglomerates in the discharge channel.

Due to the high temperatures of the relevant components, which can still be some hundred degrees a long time after the end of the casting sequence, difficulties with the monitoring of the relevant surfaces arise.

A visual judgement with the eye is extremely inaccurate and only possible over a significant distance. It has therefore been tried to sample (scan) the surface with hooks. In doing so, only very inaccurate results were achieved again. Therefore, often empirical values are used, which in many cases lead to completely wrong results.

The task of the invention is to present a possibility to securely detect and measure cylindrical surfaces of fireproof ceramic components in metallurgical applications, to achieve reliable sets of data in order to decide if or which sanctions are necessary in order to repair or exchange the affected components.

The invention proposes a device, which uses the basic idea of an endoscope, but which innovatively adapts it to the specific application. The basic idea of the invention is initially to design the device in such a way, that it features a “cold part” and a “hot part”. The “hot part” is designed to be brought into the area of the component that is to be checked, and correspondingly to conduct the required inspection “on site”. The “cold part” is placed at a significant distance from the “hot part”, in an area with significantly lower temperatures, for example room temperature.

Respectively, sensitive measuring devices such as cameras can be installed in the “cold part”, while the “hot part” is only used to direct the measuring beams to the surfaces that are to be checked.

Against this background, the inventive device is also based on the idea to feature a camera which captures certain parts of the cylindrical surface of the component that is to be checked and also conducts a distance measurement, so that with both bits of information a three dimensional image of the area that is to be checked can be determined.

In its most basic embodiment the invention relates to a device for the detection and measuring of cylindrical surfaces of fireproof ceramic components in metallurgical applications, comprising the following features:
a measuring pipe,
a camera is arranged inside or on the measuring pipe, whose objective is aligned with at least one reflection surface which is arranged inside the measuring pipe, wherein
the reflection surface runs with a distance to the objective and tilted towards the axial direction (A) of the measuring pipe,
the measuring pipe is translucent in a perimeter-segment opposite the reflection surface, such that the camera captures a segment of the cylindrical surface of the adjacent fireproof ceramic component which runs in a radial distance to the measuring pipe, at a corresponding focal length between the objective and the reflection surface,
a device for a distance measurement is arranged inside or on the measuring pipe, with which the distance of a point or an area segment on a part of the cylindrical surface of the fireproof ceramic component captured by the camera to a fixed reference point is determined.

An optical examination of a certain surface takes place with the camera and with the device for distance measurements an assessment of the distance of the corresponding surface segment to a reference point, for example the central longitudinal axis of the measuring pipe is undertaken.

The camera is for example arranged in such a way, that the direction of the corresponding focal length is coaxial to the central longitudinal axis of the measuring pipe. The reflection surface serves to capture the surface segment of the ceramic component which is running radial with a distance to the central longitudinal axis with the camera. In this respect the segment of the measuring pipe which is opposite the reflection surface is also translucent, for example open.

From the named arrangement it arises, that the reflection area runs preferably at an angle of about 45° to the central longitudinal axis of the measuring pipe, with larger or smaller angles (45+/−10°) also being possible. The given angles are related to the main direction of the corresponding light waves. In this respect the given angles are not to be understood exactly mathematically, but technically.

This is particularly valid whenever the reflection surface is not planar, but arched (curved) in order to capture larger or smaller surface segments of the fireproof component.

According to one embodiment, the device for the distance measurement includes a laser or a diode, which directs an optical beam onto a mirror which is arranged in the measuring pipe, which then directs the beam through the translucent area of the measuring pipe towards the part of the cylindrical surface of the ceramic component which is captured by the camera.

For this mirror the previous embodiments for the reflection surface are valid analogously.

It has to be considered, that the mirror can be placed in a distance from the reflection surface. Thereby particularly one embodiment is intended, where the mirror is in axial direction of the measuring pipe in front of the reflection surface, and for example wall-sided, thus in the area of the inside wall of the measuring pipe. The laser source can be arranged in such a way, that the beam runs parallel with a distance to the inside surface of the measuring pipe, before it hits the mirror.

In this arrangement the angle of inclination of the mirror is accordingly smaller than the angle of inclination of the reflection surface, if the reflected light beam should approximately hit the surface area segment which is captured by the camera centrally, which is advantageously in order to receive corresponding sets of data. In this respect the angle of the mirror is for example 10 to 30° in relation to the central longitudinal axis of the measuring pipe.

The measuring pipe is for example cylindrical. Other geometries are also possible.

The reflection surface and/or the mirror can feature a heat-proof coating on their optical side, in order to not be damaged by the high temperatures in the area of the measuring spot over longer measuring periods. Such a possible coating consists of chrome. A chromed surface can for example resist 400 to 500° C. just like that over longer periods.

From the previous description it is made clear that the device can regularly optically capture only one part of the cylindrical surface of the component that is to be checked. In this respect one embodiment suggests that the measuring pipe is designed rotatable and/or axially movable in at least the area where the reflection surface and a possible mirror are located. This allows to either continuously or in sequences capture (screen) any partial areas of the cylindrical surface of the component and to measure them respectively.

The rotation of the measuring pipe preferably takes place around the central longitudinal axis. Without further ado, the whole measuring pipe, including the corresponding installations such as the camera and the laser, can be rotated.

It is good if the measuring pipe is thermally insulated at least in the area in which the reflection surface and a possible mirror are arranged, in order to resist temperatures of for example 800° C. This insulation can be a mineral fibre insulation which is arranged behind the mirror/reflection surfaces, or in other words: between the non-optical sides of the reflection surface/the mirror and the inside wall of the measuring pipe.

The analysis of the pictures captured by the camera as well as the data from the distance measurement can take place manually, but preferably electronically. In order to do so, one embodiment of the invention suggests to design the device with a memory-unit, on which the data and images received from the camera and the device for the distance measurement are collected. These can then be analysed in an analysis unit.

If the outcome is for example, that the wear on the area of a discharge opening of a sliding plate has passed a certain limit, it results in the necessity to replace the affected sliding plate. Thereby the device according to the invention fulfils an important security aspect not only in relation to the sliding plate but also in relation to the whole installation for example in order to prevent a melt breakthrough.

The device can be utilised in a mobile manner. It is also possible to fix it via an apparatus onto a metallurgical vessel, such that the images and data are captured on defined reference-sizes.

Further features of the invention derive from the features of the sub-claims and the other application documents.

The invention is explained hereafter with respect to one embodiment.

Thereby present:

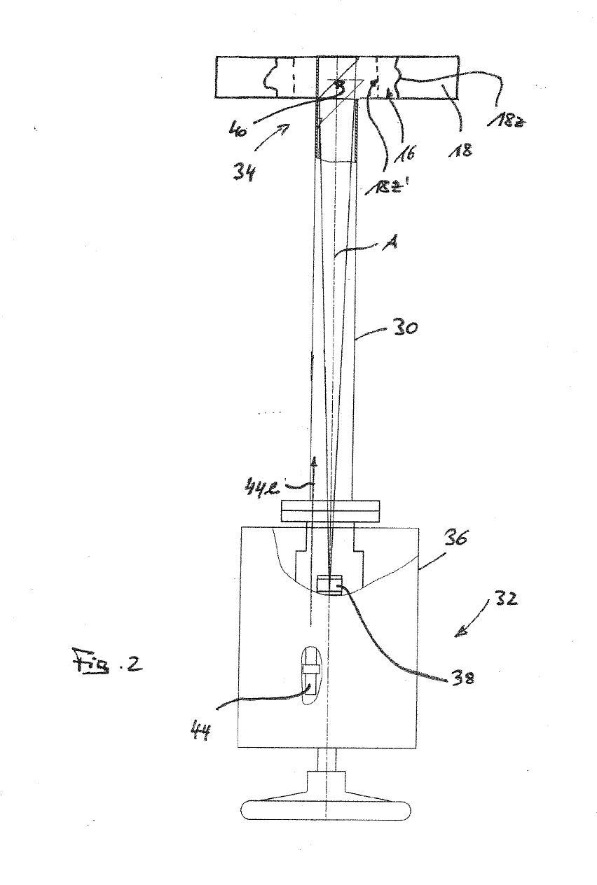

FIG. 2: A side view of an inventive device to detect and measure a discharge opening of a sliding plate.

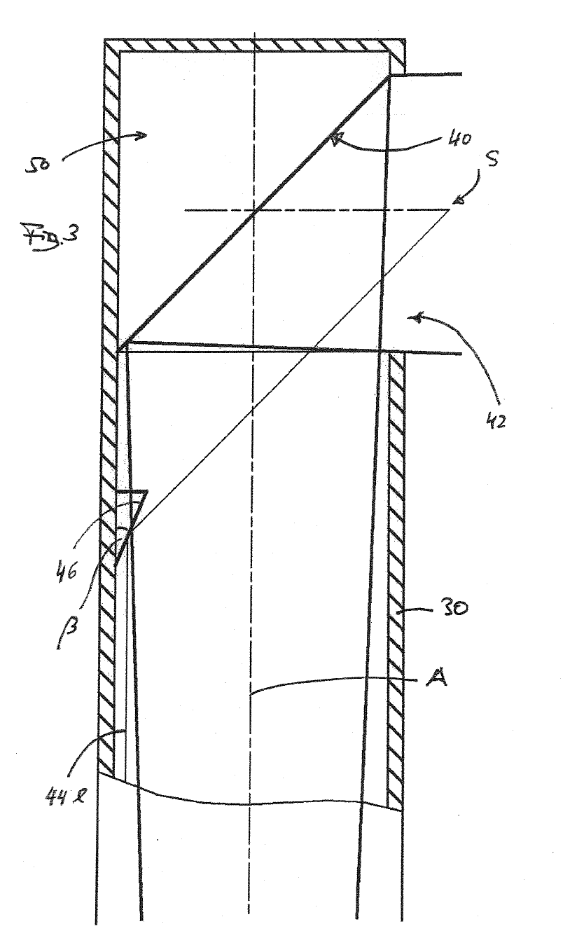

FIG. 3: An enlarged view of the segment of the device according to FIG. 1 in the area of the sliding plate.

The figures show a cylindrical measuring pipe 30 with a first end 32, the so called “cold end” and a second end 34, the so called “hot end”.

The measuring pipe 30 is widened at the first end 32 and holds a camera 38 in this segment, here an SLR camera (single lense reflec camera).

The camera 38 is aligned towards a reflection surface 40, which is located within the second end 34 of the measuring pipe 30 and therein runs within an angle of 45° towards the central longitudinal axis A of the measuring pipe 30.

The measuring pipe 30 features a corresponding opening 42 in the adjacent wall segment, so that with the means of the camera 38 a part of a cylindrical surface 18o of a sliding plate 18 can be captured/detected via the reflection surface 40.

In FIG. 2, the run of the cylindrical surface of a new sliding plate is displayed in a dashed manner (18z′), while the continuous line (18z) represents an exemplary state of wear, which shall be captured and rated by the device according to the invention.

With the adjustment of the focal length of the camera 38 to the reflection surface 40, a part of the surface 18z of the sliding plate, which runs in a radial distance to the measuring pipe 30, can be optically captured and examined. This statement on its own is not sufficient to determine the degree of wear of the sliding plate 18, because the distance from the initial surface to the worn surface can not be determined with the means of the camera 38.

For this purpose there is a laser 44 arranged in the enclosure 36 whose laser beam 44l runs parallel and with a distance to the inside wall of the measuring pipe 30 and thereby hits the mirror 46, which is located in direction of the central longitudinal axis A of the measuring pipe 30 between the camera 38 and the reflection surface 40, adjacent to the reflection area 40, as shown in FIGS. 2, 3.

Especially from FIG. 3 the further information can be extracted that the also plane surface of the mirror 46 runs in an angle β of around 23° in relation to the vertical plane. This value has been chosen in such a way that the laser beam which is reflected by the mirror 46 hits a central area segment of the cylindrical surface 18z of the sliding gate, which is captured by the camera 38, where this point is schematically labelled S in FIG. 3.

The enclosure 36 contains a (not displayed) registration unit, which saves the pictures captured by the camera 38 and also the distances from the surface 18z of the sliding plate 18 to the central longitudinal axis A of the measuring pipe 30 measured by the laser 40.

By the means of a calibration it can be, with millimetre resolution, determined from the specific distance-values how big the degree of wear is in the area of the surface 18z of the sliding plate 18, or in other words: how big the distance between the initial cylindrical surface of the new sliding plate and the corresponding actual state is, where the reference data is judged afterwards by a computer and/or by a service person, and determined how many more charges the relevant sliding plate can be used for or rather what/if reparations or replacement being necessary.

The device is designed in such a way that it can also be used at the hot aggregate. That means that the device is inserted preferably from below into the discharge drilling 16 after the effusion of the melt from the vessel 10 according to FIG. 1, until the measuring head (segment 34 at the “hot end”) lies within the area that is to be checked, as displayed in FIG. 2.

In order to do so, the whole device can be fixed to the metallurgic vessel, and preferably in such a way that the central longitudinal axis A of the measuring pipe lies within the axial extension of the ideal central longitudinal axis of the corresponding discharge opening 16.

A first shot with the camera 38 then takes place and also a first laser triangulation for the distance measurement. Afterwards, the measuring pipe 30 is twisted by a certain angle and/or axially shifted by a certain distance in order to capture an adjacent part of the surface 18z of the sliding plate 18. This process can be repeated at will and repeated in any small or big partial steps depending on which parts of the sliding plate are to be checked.

Afterwards the device is removed again. In order to increase the durability of the device it is suggested that in the second segment 34 the measuring pipe 30 features a mineral fibre insulation on the inside. Additionally the whole cavity between the reflection surface 40 and the inside wall of the measuring pipe 30 is filled with foam glass. The optical surfaces of the reflection surface 40 or respectively of the mirror 46 are chromed.

1. Method for the detection and measuring of cylindrical surfaces of fireproof ceramic components in metallurgical applications, with a device which has the following features:
1.1 a measuring pipe (30)
1.2 a camera (38) is arranged inside or on the measuring pipe (30), whose objective is aligned with at least one reflection surface (40) which is arranged inside the measuring pipe (30), wherein
1.3 the reflection surface (40) runs with a distance to the objective and tilted towards the axial direction (A) of the measuring pipe (30),
1.4 the measuring pipe (30) is translucent in a perimeter-segment opposite the reflection surface (40),
1.5 a device (44) for the distance measurement is arranged inside or on the measuring pipe (30), wherein
1.6 the camera (38) captures a segment of the cylindrical surface (18z) of the adjacent fireproof ceramic component (18) which runs in a radial distance to the measuring pipe (30), at a corresponding focal length between the objective and the reflection surface (40), and wherein
1.7 the distance of a point or an area segment on a part of the cylindrical surface (18z) of the fireproof ceramic component (18) captured by the camera (38) to a fixed reference point is determined by said device.

2. Method according to claim 1, wherein the device (44) for the distance measurement includes a laser or a diode which directs an optical beam (44l) onto a mirror (46) which is arranged in the measuring pipe (30), which then directs the beam through the translucent perimeter segment (42) of the measuring pipe (30) towards the part of the cylindrical surface (18z) of the ceramic component (18) which is captured by the camera (38).

3. (canceled)

4. Method according to claim 1, wherein the reflection surface (40) is arranged in such a way that light waves are redirected in an angle of 10-80°.

5. Method according to claim 1, wherein the reflection surface (40) is arranged in such a way that light waves are redirected in an angle of 45+/−10 °.

6. Method according to claim 2, wherein the mirror (46) is arranged in the axial direction (A) of the measuring pipe (30) in front of the reflection area (40).

7. Method according to claim 2, wherein the mirror (46) is arranged in such an angle to the axial direction (A) of the measuring pipe (30) that the reflected light beam is redirected towards a central area segment of the part of the cylindrical surface (18z) of the ceramic component (18) which is captured by the camera (38).

8. Method according to claim 1 with use of a cylindrical measuring pipe (30).

9. Method according to claim 1 with a device, wherein the reflection area (40) and/or the mirror (46) feature a heat-proof coating on their optical side.

10. Method according to claim 1 with a device, wherein the reflection surface and/or the mirror (46) are chromed on their optical side.

11. Method according to claim 1, wherein the measuring pipe (30) is rotatable and/or axially movable along its central longitudinal axis (A).

12. Method according to claim 1 with a device, wherein the measuring pipe (30) is thermally insulated at least in the area in which the reflection surface (40) and a possible mirror (46) are arranged, in order to resist temperatures of up to 800° C.

13. Method according to claim 1, wherein the data and images received from the camera (38) and from the device (44) for the distance measurement are captured by a memory-unit.

14. Method according to claim 1, wherein the data and images received from the camera (38) and from the device (44) for the distance measurement, if applicable after a previous saving, are analysed.

15. Method according to claim 1, wherein the device is fixed with an apparatus to a metallurgic vessel, on which the fireproof ceramic component (18) is arranged.
